(19) United States
(12) Patent Application Publication
(10) Pub. No.: US 2009/0294436 A1
(43) Pub. Date: Dec. 3, 2009

(54) ELECTRIC HOB

(75) Inventor: Bernhard Roth, Oberderdingen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E.G.O. Elektro-Geraetebau GmbH

(21) Appl. No.: 12/469,268

(22) Filed: May 20, 2009

Related U.S. Application Data
(60) Provisional application No. 61/056,152, filed on May 27, 2008.

(51) Int. Cl. H05B 6/12

(52) U.S. Cl. 219/622

(57) ABSTRACT

An electric cooker has a hob and a baking oven, said hob having several induction coils as heating devices for several hotplates. The cooker has a control mechanism with control electronics and power electronics with power electronics components, the control mechanism and power electronics being located in the rear area of the hob and above a hob plane. This arrangement leads to reduced heating of the power electronics by the oven.

### CROSS REFERENCE TO RELATED APPLICATIONS

This application claims priority to U.S. Provisional Application No. 61/056,152; filed on May 27, 2008, the contents of which are incorporated by reference.

### FIELD OF THE INVENTION

The invention relates to an electric hob having a cooking area, as well as a baking oven with cooking area

### BACKGROUND

WO 2007/134057 discloses the provision on an electric hob of power electronics, particularly for induction coils as heating devices for the hob and which are placed in the rear area of the electric hob or its housing, namely in the rear, lower area and a baking oven. This is intended to reduce or even completely prevent additional heating of the power electronics by the oven. However, it is not always easy to implement a cooling air guidance in this area.

### SUMMARY

The problem addressed by this invention is to provide an electric hob making it possible to avoid the disadvantages of the prior art and advantageously power the electronics, preferably also a control mechanism, arranged in a favorable, cooling-advantageous manner.

This problem is solved in one embodiment by an electric hob having the features of claim 1. Advantageous and preferred developments of the invention form the subject matter of the further claims and are explained in greater detail hereinafter. By express reference the wording of the claims is made into part of the content of the description.

The hob has several heating devices forming several hotplates of said hob. In certain circumstances several heating devices can form a size-variable hotplate. A control mechanism together with control electronics are provided for the hob and may also control the baking oven. Power electronics are provided for the hob having power electronics components, particularly electronic power switches, for example IGBTs which require cooling. In the case of a hob without an oven, the control mechanism and power electronics are located in the rear area of the hob and above a hob plane. In a cooker with a hob and baking oven the control mechanism and power electronics are located in the rear area of the hob and above the cooking area.

The invention makes it possible to place the control mechanism and in particular the power electronics at a certain distance from and not immediately adjacent to the oven and also the hob heating devices. This reduces or even eliminates a possible heat source. Moreover, in this area accessibility or both air cooling and heat radiation from the power electronics and particularly the power electronics components to the environment are much more readily possible, which is a major advantage.

In another advantageous embodiment of the invention, the power electronics, particularly also the control mechanism, are installed in a housing of the hob or cooker. In particular, this is the same or sole housing of the hob, which then has a corresponding, upwardly projecting, rear housing. Said housing for the power electronics can be formed together with the side walls of the rest of the housing and/or with a rear wall. In particular, the housing is formed by side walls drawn upwards in the rear area, an upwardly drawn rear wall and a corresponding covering in the upwards and forwards direction. In a further advantageous development it is possible to provide in said housing controls such as rotary toggles or the like for the hob or cooker, as is conventional in some electric cookers in the US. It is also advantageous to provide the control mechanism here in such a case.

Advantageously, there is a cooling system for the control mechanism and power electronics, constructed in the form of an air cooling system. With particular advantage at least one fan is provided for this purpose. Such a fan can be positioned close to a housing opening and in the air path either in front of or behind the same are located the control mechanism and/or power electronics. For cooling purposes it is also possible to provide an air guidance duct, which is linked with the fan. An air guidance duct can either lead from the fan to a following control mechanism or power electronics or in the case of a fan operating in exhausting manner from the control or power electronics to the fan, and then out of the housing. In an advantageous further embodiment of the invention, both for the control mechanism and for the power electronics are in each case provided with at least one air guidance duct. If the power electronics have several power electronics components, for example subdivided over two or three groups, each of said groups can have an air guidance duct for efficient, direct cooling. As a result of a very compact arrangement of the control mechanism, power electronics with power electronics components and fan together with the cooling air guidance in a rear, upper housing area of the hob, it is possible for the cooling air guidance duct to have a maximum length of 10 cm. This leads to an efficient, effective cooling and at the same time low constructional costs.

Advantageously, in the case of an inventive hob, the heating devices are constructed as induction heating devices with induction coils. Connecting cables from the induction coils to the power electronics run towards the rear area of the hob and are connected to the power electronics, where it is possible to make such cables relatively short. It is possible to guide or allow the connecting cables to run free from separate cable guidance elements between the induction coils and power electronics. They can run between a support plate for the heating devices and a hob plate and are consequently secured, so that assembly costs are lower.

Another advantage of the aforementioned very compact arrangement of the control mechanism and power electronics in a rear, upper housing area is that the connecting cables between the control mechanism and power electronics can be made relatively short. They are advantageously shorter than 70 cm and with particular advantage shorter than 50 cm. This economizes costs with respect to the cables and also the laying thereof.

According to a further independent inventive aspect, in the case of an aforementioned electronic hob, the control mechanism and power electronics are positioned in the rear area of the hob. Connecting cables from the induction coils to the power electronics are always and exclusively guided above the oven or cooking area below the hob. Thus, the length thereof can be kept to a minimum and the connecting cables can run in an area which is heated somewhat by the oven or cooking area. As opposed to the power electronics they in fact generate no heat.

These and further features can be gathered from the claims, description and drawings and individual features can individually or in the form of subcombinations be implemented in an embodiment of the invention and in other fields and can represent advantageous, independently protectable constructions for which protection is claimed here. The subdivision of the application into individual sections and the subheadings in no way restrict the general validity of the statements made thereunder.

### BRIEF DESCRIPTION OF THE DRAWINGS

Embodiments of the invention are diagrammatically represented in the drawings and are explained in greater detail hereinafter.

FIG. 1 illustrates an upwardly sloping view of one embodiment of an inventive electric hob with a hob and a baking oven, the controls, control mechanism and power electronics being located in a rear, upper housing area.

FIG. 2 illustrates a view from the front of the electric hob of FIG. 1 with an intimated air guidance duct.

FIG. 3 illustrates a side view of the electric hob of FIG. 1 with a broken line-represented cooking area of the oven, as well as induction coils and their connecting cables above the same.

### DETAILED DESCRIPTION OF THE EMBODIMENTS

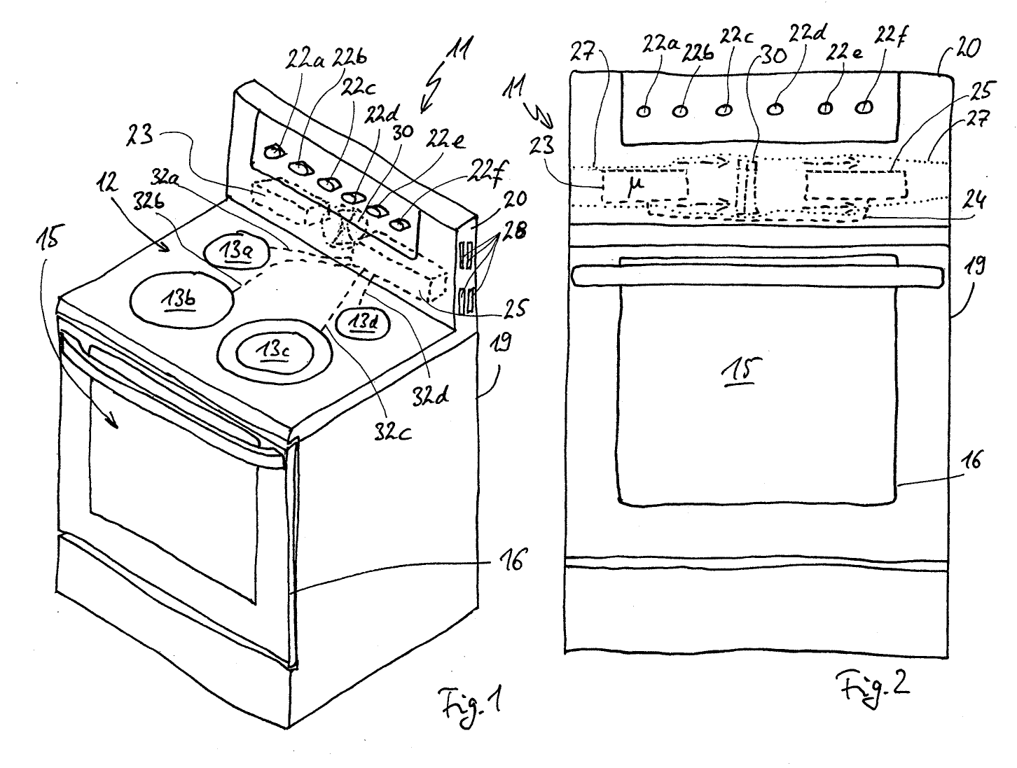

FIG. 1 shows in an upwardly sloping view of one embodiment of an inventive electric hob 11, which has an electric cooking field 12 with several hotplates 13a to 13d, which in each case have as the heating device an induction coil 14a to 14d. Below the same is provided a baking oven 15 with an oven door 16 and behind the same an oven chamber 17, as is visible in FIG. 3.

As is generally known and conventional, the electric hob 11 has a housing 19. The housing 19 has a rear, upper housing area 20, which with a substantially vertical extension runs clearly above the hob 12 or its plane. Said rear, upper housing area 20 can either be constructed in one piece from the housing 19 or metal sheets, which form said housing 19. It can alternatively comprise separate parts or sheets, which are connected to the remaining housing 19, for example firmly connected thereto, such as by screwing. However, essentially use can be made of per se known constructions of such housings with a rear, upper housing area.

On the front side 6 of the rear, upper housing area 20 are provided controls 22a to 22f. Said controls 22 can advantageously be constructed in the manner of rotary switches or rotary toggles with not shown detection devices for a rotary movement positioned behind the same. The controls 22 are connected to the control mechanism shown in broken line form, so that their signals are processed in control mechanism 23. Emanating therefrom functions of the electric hob 11 are controlled, namely either the hotplates 13 or oven 15. Thus, the control mechanism 23 is advantageously also a central control mechanism for the equipment and therefore its only control mechanism.

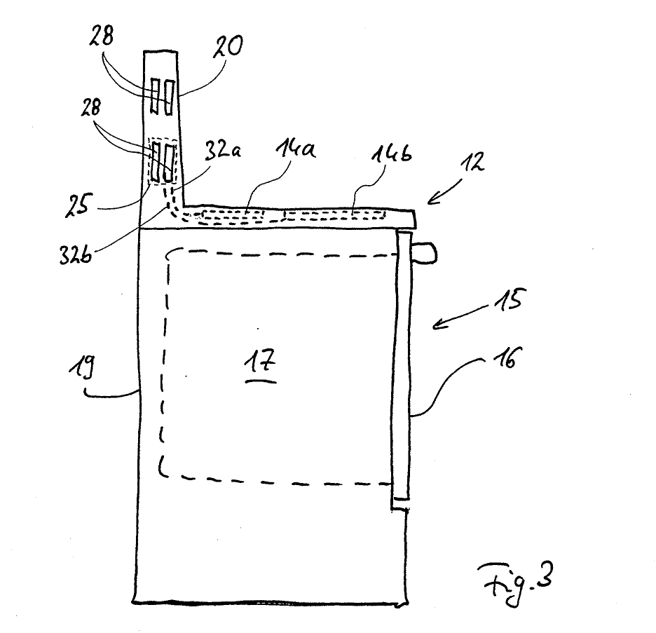

As can in particular be gathered from FIG. 2, power electronics 25 are provided in the rear, upper housing area 20 and drive or supply power at the desired level, the induction hotplates 13 or their induction coils 14, shown in broken line form in FIG. 3, and this is predetermined by the controls 22. To this extent the power electronics 25 are constructed in conventional manner, particularly with switches or power electronics components, which are not separately shown so as not to overburden representation, but which are advantageously constructed as IGBTs or the like.

As can be seen in FIG. 3, the power electronics 25 shown in broken line form, are a relatively long distance from the oven chamber 17 in the rear, upper housing area 20, so that they are not heated or only heated to a very minor extent by the same. With the power electronics 25 is linked the per se known problem that the power components in operation generate considerable heat, which must be dissipated. Through the inventive placing far from the oven chamber 17 the thermal problem caused by them is minimized.

FIG. 2 also shows in dotted line form an air guidance duct 27, which leads from ventilating slots 28 on the left-hand side of the rear, upper housing area 20 to further ventilating slots 28 on the right-hand side thereof, i.e. traversing the same. The air guidance duct 27 can be substantially closed. By means of a roughly centrally positioned fan 30, shown in dot-dash line form, cooling air is transported in accordance with the dot-dash arrow in FIG. 2 from left to right. Thus, said cooling air firstly cools the control mechanism 23, which in operation generates little heat and which consequently does not have to be particularly strongly cooled. In particular, the cooling air moved by the fan 30 cools the power electronics 25 or their power electronics components located behind the fan 30. Therefore this is an example of how with a single fan 30 both control mechanism 23 and power electronics 25 can be cooled. In some cases it is possible to remove the control mechanism 23 from the cooling air or the air guidance duct 27. Then the corresponding ventilating slots can be provided for the suction of cooling air on the front side or advantageously the rear side of the rear, upper housing area 20. The advantage of the present construction of the air guidance duct 27 is that relatively cool air is available for suction on the sides of the rear, upper housing area 20, at least when compared with suction directly above the cooking field 12 or at the rear of electric hob 11, where possibly there is accumulated heat from the oven chamber 17.

In an extension of the invention, it is obviously possible to provide several such fans. The power electronics 25 can also be subdivided into two modules, for example if they in each case drive two of the induction coils 14 of hotplates 13.

It can be gathered from FIG. 2 that the control mechanism 23 is connected to power electronics 25 by a connecting cable 24, shown in broken line form. Said connecting cable 24 is appropriately guided outside the air guidance duct 27, but this is not necessarily the case.

FIGS. 1 and 3 show how connecting cables 32a to 32d are guided from each individual induction coil 14a to 14d of hotplates 13a to 13d to the power electronics 25. FIG. 1 shows that the connecting cables 32 can be made very short, because there is a relatively limited spacing from the power electronics 25. FIG. 3 shows that the connecting cables 32 are always led well above the oven chamber 17, so that here an adequately thick thermal insulation can be provided so as to prevent thermal influencing of both the connecting cables 32 above the same and in particular the induction coil 14. They also require no cable guidance elements or the like.

The invention is with particular advantage applied to the electric hob 11 shown in the drawings and which is a combination of cooking field 12 and baking oven 15 in a single appliance. Normally there is high thermal loading as a result of the operation of baking oven 15 due to the relatively limited distance between the latter or the oven chamber 17 and the cooking field 12.

As an alternative to the arrangement according to FIG. 2 of control mechanism 23 in the lower part of the rear, upper housing area 20, it could also be located further upwards and advantageously almost beneath the top side. There would then be an even greater distance from the oven chamber 17 or baking oven 15. This has no negative effects with respect to the cooling air guidance. The ventilating slots for a cooling air exit could for example be located on the top side, which permits a suction of very cold air on the side of electric hob 11 or housing area 20.

1. An electric hob with an electric cooker with a cooking area and with a baking oven having an oven chamber, said hob having several heating devices for several hotplates on said cooking area, wherein said hob comprises a control mechanism with control electronics, as well as power electronics with power electronics components, wherein said control mechanism and said power electronics are located in a rear area of said hob and above a plane of said cooking area.

2. The electric hob according to claim 1, wherein said hob has a housing and said power electronics are incorporated into said housing.

3. The electric hob according to claim 2, wherein said housing is formed with side walls and a rear wall of said hob.

4. The electric hob according to claim 1, wherein a cooling system is provided for air cooling of said control mechanism and said power electronics, wherein said cooling system comprises at least one fan.

5. The electric hob according to claim 4, wherein said cooling system has an air guidance duct, which leads from said at least one fan to said control mechanism or said power electronics.

6. The electric hob according to claim 5, wherein at least one said air guidance duct is provided for both said control mechanism and for said power electronics.

7. The electric hob according to claim 5, wherein said air guidance duct for said cooling air has a maximum length of 10 cm.

8. The electric hob according to claim 1, wherein said heating devices are induction heating devices with induction coils, and wherein connecting cables run from said induction coils in said rear area of said hob to said power electronics.

9. The electric hob according to claim 8, wherein said connecting cables run from separate cable guidance elements between said induction coils and said power electronics, wherein said connecting cables run and are held between a support plate for said heating devices and a hob plate.

10. The electric hob according to claim 1, wherein said connecting cables between said control mechanism and said power electronics are shorter than 70 cm.

11. The electric hob according to claim 1, wherein said connecting cables between said control mechanism and said power electronics are shorter than 50 cm.

12. An electric hob with an electric cooker with a cooking area and with a baking oven, said hob having several induction coils as heating devices for several hotplates on said cooking area, said hob comprising a control mechanism with control electronics, as well as power electronics with power electronics components, wherein said control mechanism and said power electronics are located in a rear area of said hob, said hob further comprising connecting cables running from said induction coils to said power electronics, and wherein said connecting cable are guided above said oven.
